(19) United States
(12) Patent Application Publication
(10) Pub. No.: US 2010/0103657 A1
(43) Pub. Date: Apr. 29, 2010

(54) Custom assembly light-emitting module

(76) Inventors: Chien-Chen Teng, Keelung City (TW); Fang-Po Wang, Yonghe City (TW); Wen-Chieh Chang Chien, Jhonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/289,288

(22) Filed: Oct. 24, 2008

(51) Int. Cl. F21S 4/00

(52) U.S. Cl. 362/223

(57) ABSTRACT

An improved custom assembly light-emitting module includes a light-emitting unit and a lens unit. The light-emitting unit has two first retaining structures respectively extended upwards from two opposite lateral sides of the light-emitting unit. The lens unit has a solid lens and two second retaining structures respectively formed on two opposite lateral sides of the solid lens. The lens unit is detachably disposed above the light-emitting unit by matching the two first retaining structures and the two second retaining structures. Hence, the light-emitting unit and the lens unit are changeable according to different requirements of users. In addition, each first retaining structure has a concave retaining portion formed on its outside, and the light-emitting unit is inverted and retained in a hooking unit by the two concave retaining portions mating with the hooking unit.

### BACKGROUND OF THE INVENTION

1. Field of the Invention

The present invention relates to a light-emitting module, and particularly relates to an improved custom assembly light-emitting module having a light-emitting element and a solid lens all of which are replaceable according to user requirements.

2. Description of Related Art

A traditional light-emitting device is used to provide illumination for humans, such as simple illumination or illumination for enhancing the aspect of the environment. However, the characteristics of traditional light-emitting devices are fixed such as fixed heat-dissipating effect, fixed light-emitting effect, and fixed light-projecting angle.

When the user purchases a traditional light-emitting device, the components of the traditional light-emitting device cannot be replaced. In other words, because the characteristics of a traditional light-emitting device are fixed, the components of the traditional light-emitting device cannot be replaced according to the user's different requirements.

### SUMMARY OF THE INVENTION

One particular aspect of the present invention is to provide an improved custom assembly light-emitting module that includes a light-emitting unit and a lens unit that are replaceable according to the user's different requirements. Hence, the light-emitting unit is replaceable according to different light-emitting effects, and the lens unit is replaceable according to different light-projecting angles.

In order to achieve the above-mentioned aspects, the present invention provides an improved custom assembly light-emitting module, including: a light-emitting unit and a lens unit. The light-emitting unit has two first retaining structures. The lens unit has two second retaining structures. The lens unit and the light-emitting unit are detachably assembled together by matching the two first retaining structures and the two second retaining structures. Moreover, the two first retaining structures are respectively extended upwards from two opposite lateral sides of the light-emitting unit, the lens unit has a solid lens, the two second retaining structures are respectively formed on two opposite lateral sides of the solid lens, and the lens unit is detachably disposed above the light-emitting unit. In addition, each first retaining structure has a concave retaining portion formed on its outside. The light-emitting unit is inverted and retained in a hooking unit by the two concave retaining portions mating with the hooking unit.

In order to achieve the above-mentioned aspects, the present invention provides an improved custom assembly light-emitting module, including: a light-emitting unit and a lens unit. The light-emitting unit has two first retaining structures. The lens unit has two second retaining structures. The lens unit and the light-emitting unit are detachably assembled together by matching the two first retaining structures and the two second retaining structures. Moreover, the two first retaining structures are disposed on two opposite lateral sides of the light-emitting unit, the lens unit has a solid lens, the two second retaining structures are respectively extended downwards from two opposite lateral sides of the solid lens, and the lens unit is detachably disposed above the light-emitting unit. In addition, each second retaining structure has a concave retaining portion formed on its outside. The light-emitting unit is inverted and retained in a hooking unit by the two concave retaining portions mating with the hooking unit.

In order to achieve the above-mentioned aspects, the present invention provides an improved custom assembly light-emitting module, including: a light-emitting unit, a lens unit, and two cover units. The light-emitting unit has a circuit substrate, a plurality of light-emitting elements electrically disposed on the circuit substrate, and two first retaining structures formed on two opposite lateral sides of the light-emitting unit. The lens unit has a hollow transparent structure, a solid lens integratedly with the hollow transparent structure, and the two second retaining structures disposed on an inner surface of the hollow transparent structure. The two second retaining structures correspond to the two first retaining structures, respectively. Hence, the lens unit and the light-emitting unit are detachably assembled together by matching the two first retaining structures and the two second retaining structures.

Hence, the present invention has the following advantages:

1. The light-emitting unit is replaceable, so that the space, the color, the number and the power of the light-emitting elements can be changed according to user's requirement.

2. The lens unit is replaceable (the lens unit is detachably disposed above the light-emitting unit by matching the two first retaining structures and the two second retaining structures), so that the solid lens can be changed according to the different light-projecting angles the user's requirement.

3. In one embodiment, the light-emitting unit is inverted and retained in a hooking unit by the two concave retaining portions mating with the hooking unit. Hence, the light beams generated by the light-emitting elements pass through the solid lens and generate upwards projecting light beams with predetermined light-projecting angles so as to provide brightness the user's requirement.

4. In another embodiment, the lens unit is inverted and retained under a hooking unit by the two concave retaining portions matching with the hooking unit. Hence, the light beams generated by the light-emitting elements pass through the solid lens and generate upwards projecting light beams with predetermined light-projecting angles so as to provide brightness the user's requirement.

5. In another embodiment, the two second retaining structures correspond to the two first retaining structures respectively. Hence, the lens unit is detachably disposed in the hollow transparent structure by matching the two first retaining structures and the two second retaining structures.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1A is a perspective, exploded view of an improved custom assembly light-emitting module according to the first embodiment of the present invention;

FIG. 1B is a perspective, assembled view of an improved custom assembly light-emitting module when a cover unit opening according to the first embodiment of the present invention;

FIG. 1C is a lateral, schematic view of an improved custom assembly light-emitting module without the cover unit according to the first embodiment of the present invention;

FIG. 1D is a lateral, schematic view of an improved custom assembly light-emitting module fixed by a hooking unit according to the first embodiment of the present invention;

FIG. 1E is a lateral, schematic view of an improved custom assembly light-emitting module using another type of lens unit according to the first embodiment of the present invention;

FIG. 2A is a perspective, exploded view of an improved custom assembly light-emitting module according to the second embodiment of the present invention;

FIG. 2B is a perspective, assembled view of an improved custom assembly light-emitting module when a cover unit opening according to the second embodiment of the present invention;

FIG. 2C is a lateral, schematic view of an improved custom assembly light-emitting module without the cover unit according to the second embodiment of the present invention;

FIG. 2D is a lateral, schematic view of an improved custom assembly light-emitting module fixed by a hooking unit according to the second embodiment of the present invention;

FIG. 3A is a perspective, exploded view of an improved custom assembly light-emitting module according to the third embodiment of the present invention;

FIG. 3B is a perspective, assembled view of an improved custom assembly light-emitting module when a cover unit opening according to the third embodiment of the present invention; and

FIG. 3C is a lateral, schematic view of an improved custom assembly light-emitting module without the cover unit according to the third embodiment of the present invention.

### DETAILED DESCRIPTION OF PREFERRED EMBODIMENTS

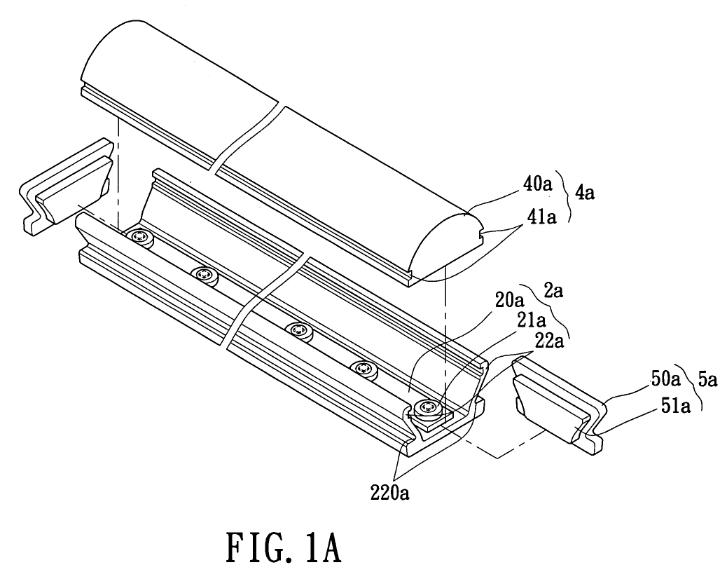

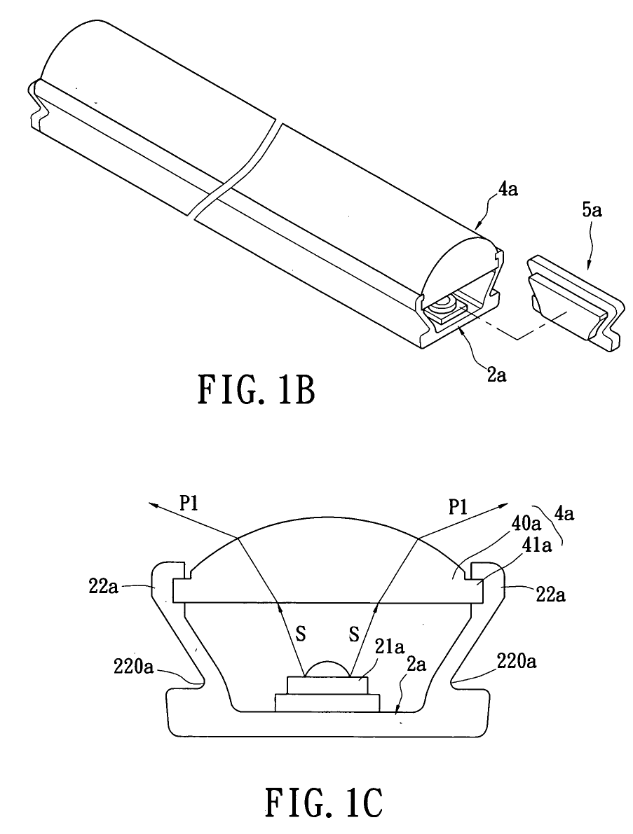

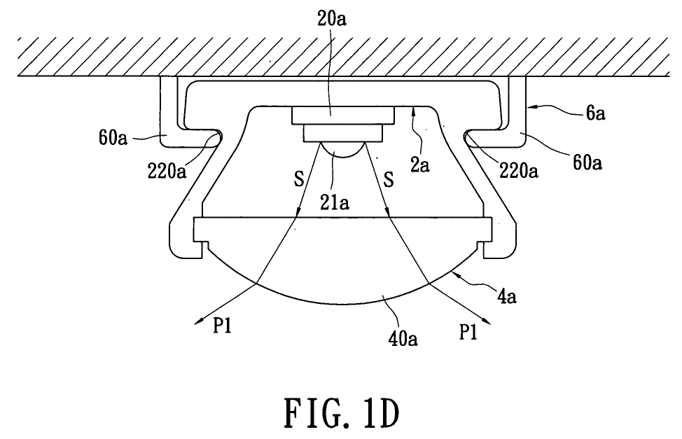

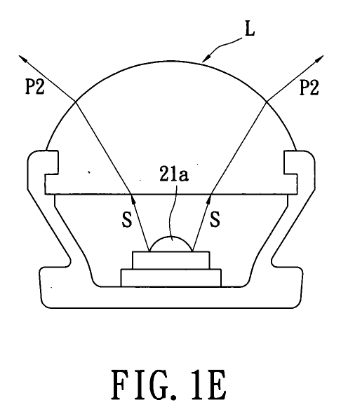

Referring to FIGS. 1A to 1D, the first embodiment of the present invention provides an improved custom assembly light-emitting module, including: a light-emitting unit 2a, a lens unit 4a, and two cover unit 5a.

The light-emitting unit 2a has a circuit substrate 20a, a plurality of light-emitting elements 21a electrically disposed on the circuit substrate 20a, and two first retaining structures 22a extended upwards from the bottom side of the circuit substrate 20a respectively. Each first retaining structure 21a has a concave retaining portion 220a formed on its outside. In addition, the space, the color, the number and the power of the light-emitting elements 21a of the light-emitting unit 2a can be changed according to user's requirement. In the present invention, the light-emitting elements 21a are LEDs.

The lens unit 4a has a solid lens 40a and two second retaining structures 41a formed on two opposite lateral sides of the solid lens 40a. The two retaining structures 41a correspond to the two first retaining structures 22a respectively. Hence, the lens unit 4a is detachably disposed above the light-emitting unit 2a by matching the two first retaining structures 22a and the two second retaining structures 41a. In the first embodiment, the two first retaining structures 22a are two first sliding grooves facing each other, the two second retaining structures 41a are two second sliding grooves in opposite direction to each other, the two first sliding grooves and the two second sliding grooves are matched to slide in each other. However, the matching relation between the two first sliding grooves and the two second sliding grooves is just an example. The lens unit 4a can be detachably disposed above the light-emitting unit 2a by any matching method.

The two cover units 5a are respectively covering two opposite lateral sides of the light-emitting unit 2a. Each cover unit 5a has a cover body 50a and a protruding portion 51a projecting from the cover body 50a and fitted tightly between the two first retaining structures 22a.

Referring to FIG. 1C, the light beams S generated by the light-emitting elements 21a pass through the solid lens 40a and generate projecting light beams P1 with predetermined light-projecting angles. Hence, the solid lens 40a can be changed according to the different light-projecting angles the user's requirement.

Referring to FIG. 1D, the light-emitting unit 2a is inverted and retained in a hooking unit 6a by the two concave retaining portions 220a mating with the hooking unit 6a. For example, when a user wants to place the improved custom assembly light-emitting module of the present invention on a ceiling (or on a wall or on any object), the light-emitting unit 2a can be inverted and retained between two hooking structures 60a of the hooking unit 6a by matching the two concave retaining portions 220a and the hooking structures 60a fixed on the ceiling. The circuit substrate 20a is hidden in the hooking unit 6a, and the solid lens 40a is exposed out of the hooking unit 6a. Hence, the light beams S generated by the light-emitting elements 21a pass through the solid lens 40a and generate upwards projecting light beams P1 with predetermined light-projecting angles so as to provide brightness the user's requirement. In addition, the present invention can generate different light-projecting angles due to the replacement of the solid lens 40a.

Referring to FIG. 1E, the difference between FIG. 1E and FIG. 1C is that: the solid lens 40a has been replaced by another lens L in FIG. 1E. Hence, the light beams S generated by the light-emitting elements 21a pass through the lens L and generate projecting light beams P2 with another predetermined light-projecting angle.

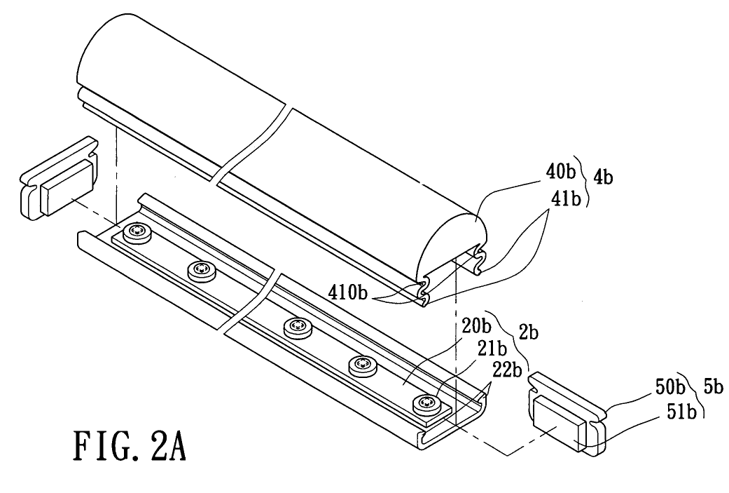

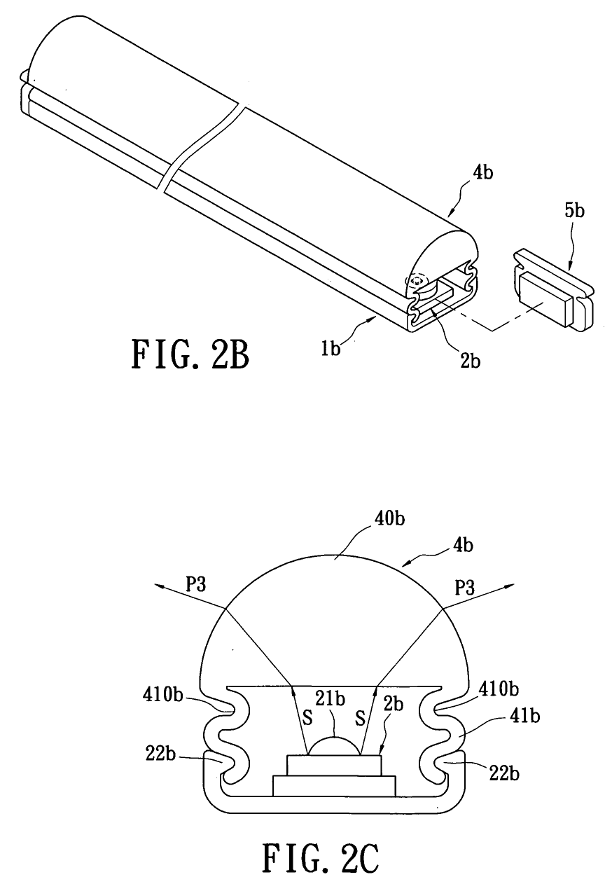

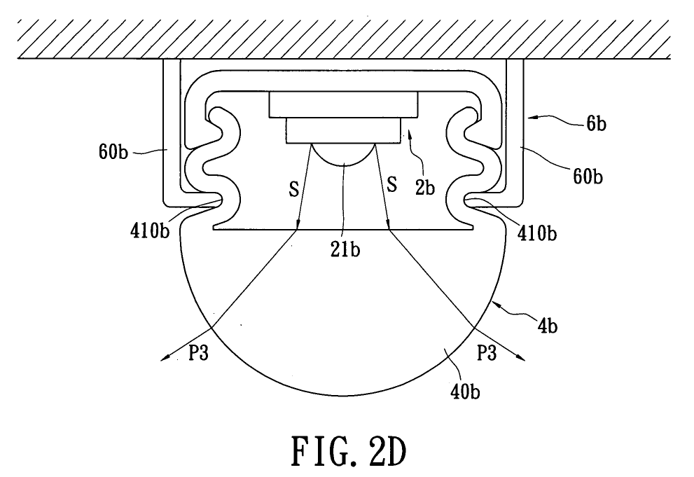

Referring to FIGS. 2A to 2D, the second embodiment of the present invention provides an improved custom assembly light-emitting module, including: a light-emitting unit 2b, a lens unit 4b, and two cover unit 5b.

The light-emitting unit 2b has a circuit substrate 20b, a plurality of light-emitting elements 21b electrically disposed on the circuit substrate 20b, and two first retaining structures 22b extended upwards from the bottom side of the circuit substrate 20b. In addition, the space, the color, the number and the power of the light-emitting elements 21b can be changed according to user's requirement.

The lens unit 4b has a solid lens 40b and two second retaining structures 41b extending downwards from two opposite lateral sides of the solid lens 40b. Each second retaining structure 41b has a concave retaining portion 410b formed on its outside. The two second retaining structures 41b correspond to the two first retaining structures 22b respectively. Hence, the lens unit 4b is detachably disposed above the light-emitting unit 2b by matching the two first retaining structures 22b and the two second retaining structures 41b. In the second embodiment, the two first retaining structures 22b are two first sliding grooves facing each other, the two second retaining structures 41b are two second sliding grooves in opposite direction to each other, the two first sliding grooves and the two second sliding grooves are matched to slide in each other. However, the matching relation between the two first sliding grooves and the two second sliding grooves is just an example. The lens unit 4b can be detachably disposed above the light-emitting unit 2b by any matching method.

The two cover units 5b are respectively covering two opposite lateral sides of the light-emitting unit 2b. Each cover unit 5b has a cover body 50b and a protruding portion 51b projecting from the cover body 50b and fitted tightly between the two second retaining structures 41b.

Referring to FIG. 2C, the light beams S generated by the light-emitting elements 21b pass through the solid lens 40b and generate projecting light beams P3 with predetermined light-projecting angles. Hence, the solid lens 40b is changeable according to the different light-projecting angles the user's requirement.

Referring to FIG. 2D, the lens unit 4b is inverted and retained under a hooking unit 6b by the two concave retaining portions 410b matching with the hooking unit 6b. For example, when a user wants to place the improved custom assembly light-emitting module of the present invention on a ceiling (or on a wall or on any object), the light-emitting unit 2b can be inverted and retained between two hooking structures 60b of the hooking unit 6b by matching the two concave retaining portions 410b and the hooking structures 60b fixed on the ceiling. The light-emitting unit 2b is hidden in the hooking unit 6b, and the solid lens 40b is exposed out of the hooking unit 6b. Hence, the light beams S generated by the light-emitting elements 21b pass through the solid lens 40b and generate upwards projecting light beams P3 with predetermined light-projecting angles so as to provide brightness the user's requirement. In addition, the present invention can generate different light-projecting angles due to the replacement of the solid lens 40b.

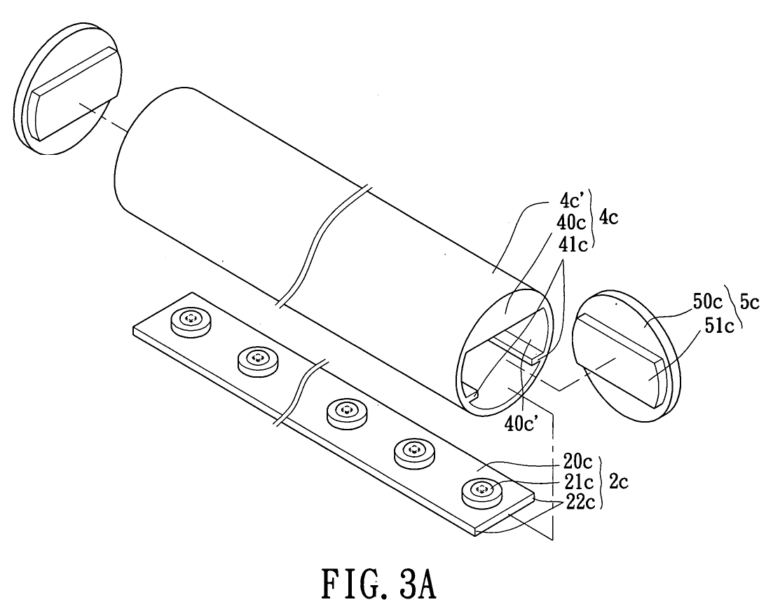

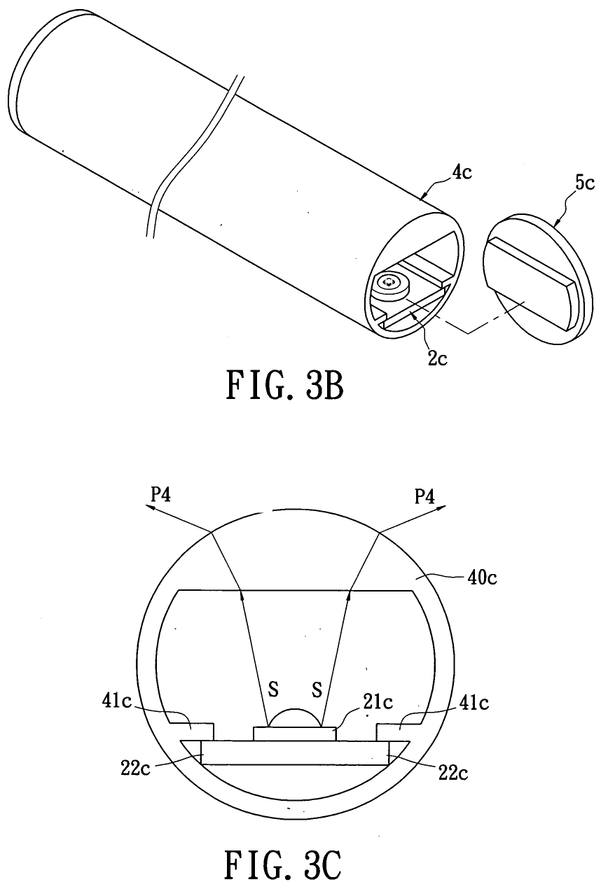

Referring to FIGS. 3A to 3C, the third embodiment of the present invention provides an improved custom assembly light-emitting module, including: a light-emitting unit 2c, a lens unit 4c, and two cover unit 5c.

The light-emitting unit 2c has a circuit substrate 20c, a plurality of light-emitting elements 21c electrically disposed on the circuit substrate 20c, and two first retaining structures 22c disposed on two opposite lateral sides of the circuit substrate 20c. In addition, the space, the color, the number and the power of the light-emitting elements 21c can be changed according to user's requirement. The lens unit 4c has a hollow transparent structure 4c′, a solid lens 40c integratedly with the hollow transparent structure 4c′, and two second retaining structures 41c disposed on an inner surface 40c′ of the hollow transparent structure 4c′. In addition, the solid lens 40c is disposed on the top side of the hollow transparent structure 4c′ and the solid lens 40c is located above the light-emitting unit 2c. The two second retaining structures 41c correspond to the two first retaining structures 22c respectively. Hence, the lens unit 4c is detachably disposed in the hollow transparent structure 4c′ by matching the two first retaining structures 22c and the two second retaining structures 41c. In the third embodiment, the two first retaining structures 22c are disposed in opposite direction to each other, the two second retaining structures 41c are disposed facing each other and on the inner surface 40c′ of the hollow transparent structure 4c′. The two first retaining structures 22c and the two second retaining structures 41c are matched to slide in each other.

The two cover units 5c are respectively covering two opposite lateral sides of the lens unit 4c. Each cover unit 5c has a cover body 50c and a protruding portion 51c projecting from the cover body 50c and fitted tightly in the hollow transparent structure 4c′.

Referring to FIG. 3C, the light beams S generated by the light-emitting elements 21c pass through the solid lens 40c and generate projecting light beams P4 with predetermined light-projecting angles. Hence, the solid lens 40c is changeable according to the different light-projecting angles the user's requirement.

In conclusion, the light-emitting unit is replaceable according to different light-emitting effects, and the lens unit is replaceable according to different light-projecting angles. Hence, the present invention has the following advantages:

1. The light-emitting unit is replaceable, so that the space, the color, the number and the power of the light-emitting elements can be changed according to user's requirement.

2. The lens unit is replaceable (the lens unit is detachably disposed above the light-emitting unit by matching the two first retaining structures and the two second retaining structures), so that the solid lens can be changed according to the different light-projecting angles the user's requirement.

3. In the first embodiment, the light-emitting unit 2a is inverted and retained in a hooking unit 6a by the two concave retaining portions 220a mating with the hooking unit 6a. Hence, the light beams S generated by the light-emitting elements 21a pass through the solid lens 40a and generate upwards projecting light beams P1 with predetermined light-projecting angles so as to provide brightness the user's requirement.

4. In the second embodiment, the lens unit 4b is inverted and retained under a hooking unit 6b by the two concave retaining portions 410b matching with the hooking unit 6b. Hence, the light beams S generated by the light-emitting elements 21b pass through the solid lens 40b and generate upwards projecting light beams P3 with predetermined light-projecting angles so as to provide brightness the user's requirement.

5. In the third embodiment, the two second retaining structures 41 c correspond to the two first retaining structures 22c respectively. Hence, the lens unit 4c is detachably disposed in the hollow transparent structure 4c′ by matching the two first retaining structures 22c and the two second retaining structures 41c.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An improved custom assembly light-emitting module, comprising:
a light-emitting unit having two first retaining structures; and
a lens unit having two second retaining structures, wherein the lens unit and the light-emitting unit are detachably assembled together by matching the two first retaining structures and the two second retaining structures.

2. The improved custom assembly light-emitting module as claimed in claim 1, wherein the two first retaining structures are respectively extended upwards from two opposite lateral sides of the light-emitting unit, the lens unit has a solid lens, the two second retaining structures are respectively formed on two opposite lateral sides of the solid lens, and the lens unit is detachably disposed above the light-emitting unit.

3. The improved custom assembly light-emitting module as claimed in claim 2, wherein the light-emitting unit has a circuit substrate and a plurality of light-emitting elements electrically disposed on the circuit substrate.

4. The improved custom assembly light-emitting module as claimed in claim 3, wherein the two first retaining structures are extended upwards from the bottom side of the circuit substrate.

5. The improved custom assembly light-emitting module as claimed in claim 2, wherein the two first retaining structures are two first sliding grooves facing each other, the two second retaining structures are two second sliding grooves in opposite direction to each other, and the two first sliding grooves and the two second sliding grooves are matched to slide in each other.

6. The improved custom assembly light-emitting module as claimed in claim 2, wherein each first retaining structure has a concave retaining portion formed on its outside.

7. The improved custom assembly light-emitting module as claimed in claim 6, wherein the light-emitting unit is inverted and retained in a hooking unit by the two concave retaining portions mating with the hooking unit.

8. The improved custom assembly light-emitting module as claimed in claim 2, further comprising: two cover units respectively covering two opposite lateral sides of the light-emitting unit.

9. The improved custom assembly light-emitting module as claimed in claim 8, wherein each cover unit has a cover body and a protruding portion projecting from the cover body and fitted tightly between the two first retaining structures.

10. The improved custom assembly light-emitting module as claimed in claim 1, wherein the two first retaining structures are disposed on two opposite lateral sides of the light-emitting unit, the lens unit has a solid lens, the two second retaining structures are respectively extended downwards from two opposite lateral sides of the solid lens, and the lens unit is detachably disposed above the light-emitting unit.

11. The improved custom assembly light-emitting module as claimed in claim 10, wherein the light-emitting unit has a circuit substrate and a plurality of light-emitting elements electrically disposed on the circuit substrate.

12. The improved custom assembly light-emitting module as claimed in claim 11, wherein the two first retaining structures are extended upwards from the bottom side of the circuit substrate.

13. The improved custom assembly light-emitting module as claimed in claim 10, wherein the two first retaining structures are two first sliding grooves facing each other, the two second retaining structures are two second sliding grooves in opposite direction to each other, and the two first sliding grooves and the two second sliding grooves are matched to slide in each other.

14. The improved custom assembly light-emitting module as claimed in claim 10, wherein each second retaining structure has a concave retaining portion formed on its outside.

15. The improved custom assembly light-emitting module as claimed in claim 14, wherein the light-emitting unit is inverted and retained in a hooking unit by the two concave retaining portions mating with the hooking unit.

16. The improved custom assembly light-emitting module as claimed in claim 10, further comprising: two cover units respectively covering two opposite lateral sides of the light-emitting unit.

17. The improved custom assembly light-emitting module as claimed in claim 16, wherein each cover unit has a cover body and a protruding portion projecting from the cover body and fitted tightly between the two second retaining structures.

18. The improved custom assembly light-emitting module as claimed in claim 1, wherein the two first retaining structures are formed on two opposite lateral sides of the light-emitting unit, the lens unit has a hollow transparent structure and a solid lens integratedly with the hollow transparent structure, the two second retaining structures are disposed in the hollow transparent structure, and the light-emitting unit is detachably disposed in the hollow transparent structure.

19. The improved custom assembly light-emitting module as claimed in claim 18, wherein the solid lens is disposed on the top side of the hollow transparent structure and is disposed above the light-emitting unit.

20. The improved custom assembly light-emitting module as claimed in claim 18, wherein the two second retaining structures face each other and are disposed on an inner surface of the hollow transparent structure.
